(19) United States
(12) Patent Application Publication
(10) Pub. No.: US 2024/0317645 A1
(43) Pub. Date: Sep. 26, 2024

(54) Binder Composition and Method Thereof

(71) Applicant: Binish Desai, Harrisburg, IL (US)

(72) Inventor: Binish Desai, Harrisburg, IL (US)

(21) Appl. No.: 18/123,375

(22) Filed: Mar. 20, 2023

(51) Int. Cl. C04B 26/28; C04B 26/26

(52) U.S. Cl. CPC C04B 26/28; C04B 26/26

(57) ABSTRACT

A dry binder composition comprised of biopolymers, an emulsifier and at least one starch, plasticizer, mineral admixture, and filler material is provided. Furthermore, methods of manufacturing a liquid binder composition that can be used to make various bricks, pavers, flooring and concrete compositions is disclosed. I one embodiment a concrete composition made from combining the binder composition and garbage of bituminous derivatives is disclosed.

### BACKGROUND OF THE DISCLOSURE

Garbage of bituminous (a/k/a “GOB”) is a waste that is generated from the coal mining industry that leaches iron, manganese and aluminum. It produces acid drainage and releases sediments and coal fines (tiny coal particles) that can damage water resources. GOB piles generate a large amount of carbon dioxide and methane greenhouse gases along with carbon monoxide, mercury, and other toxic substances. It is estimated that coal dump sites produce 1,200 to 8,200 kilograms CO₂/m² annually. Methane emissions from coal mining and abandoned coal mines accounted for about 7-8% of total U.S. methane emissions in 2019.

GOB's status as a notorious and readily-available waste product necessitates a technology that may not only mitigate GOB's noxious environmental effects but also convert GOB from being waste into a useful and valuable construction material.

### SUMMARY OF THE INVENTION

The present invention relates to binder compositions and the method of producing binder composition products and concrete products therewith. A formulation for a dry binder composition is provided that comprises a first biopolymer, a second biopolymer, at least one starch, at least one plasticizer, at least one mineral admixture, and at least one filler material.

In another aspect, the invention provides a method for producing a liquid binder composition product. The method comprises combining at least one starch and emulsifier together with water, wherein the ratio of water to the combined at least one starch and emulsifier is between about 1:10 to about 2:10; mixing the combined starch, emulsifier, and water is mixed thoroughly to create a first mixture; combining a first biopolymer, a second biopolymer, at least one plasticizer, at least one mineral admixture, at least one filler material, and water thoroughly to create a second mixture; and combining the first mixture and second mixture such that the ratio of water in the combined first mixture and second mixture to the at least one starch, emulsifier, first biopolymer, second biopolymer, at least one plasticizer, at least one mineral admixture, and at least one filler material is maintained between about 1:2 to about 2:5.

### BRIEF DESCRIPTION OF FIGURES

FIG. 1 is a process flow of an exemplary binder.

FIG. 2 is a process flow of a concrete product utilizing an exemplary binder.

FIG. 3 is a process flow of an exemplary binder.

FIG. 4 is a composition chart of an exemplary binder.

### DETAILED DESCRIPTION

A dry binder composition and method of producing a liquid binder composition is provided. A concrete composition containing the dry binder formulation is also provided.

The present invention is premised, at least in part, upon a formulation for a dry binder composition that comprises a first biopolymer, a second biopolymer, at least one starch, at least one plasticizer, at least one mineral admixture, and at least one filler material.

In an exemplary embodiment, the first and second biopolymer is selected from the group comprising acacia gun, psyllium gum, quince gum, tamarind gum, ghatti gun, gum arabic, tragacanth gum, carageenan, xanthan gum, gelatin, casein sodium, guar gum, gum tare, glue plants (funori), agar, furcellaran, tamarind seed polysaccharides, gumkaraya, hibiscus, pectin, sodium alginate, pullulan, gellan gum, locust bean gum, albumin, various starches, and mixtures or derivatives thereof.

In another exemplary embodiment, the dry binder composition comprises the first biopolymer in an amount between about 20% by weight of the dry binder composition and 35% by weight of the dry binder composition.

In another exemplary embodiment, the dry binder composition comprises the second biopolymer in an amount between about 10% by weight of the dry binder composition and 20% by weight of the dry binder composition.

In another exemplary embodiment, the at least one starch is selected from the group comprising corn starch, potato starch, rice starch, wheat starch, amylopectin, amylose, seagel, starch acetates, starch hydroxyethylethers, ionic starches, long-chain alkylstarches, dextrins, amine starches, phosphates starches, and dialdehyde starches. In some embodiments, the starch comprises pregelatinized starch, an acid modified starch, an alkylated starch, or other modified starches. Starch can be used to increase the bonding property of the composition upon addition of water.

In one exemplary embodiment, the dry binder composition comprises the at least one starch in an amount between about 1% by weight of the dry binder composition and 10% by weight of the dry binder composition.

In another exemplary embodiment, the at least one plasticizer is selected from the group comprising soybean meal, polyols (glycerin, ethylene glycol, triethylene glycol, sorbitol, diethylene glycol dibenzoate), esters of phthalic acid (dioctyl phthalate), epoxidized vegetable oils (soybean, linseed), esters of fatty acids (stearic acid, oleic acid, palmitic acid, sebacic acid), esters of phosphoric acid, polyvinyl pyrrolidone, polyethylene glycol, polyvinyl alcohol, polyvinylmethyl ether, polyacrylic acids, polyacrylic acid salts, polyvinyl acrylic acids, polyvinyl acrylic acid salts, polyacrylimides, ethylene oxide polymers, and polylactic acid.—include polyvinyl pyrrolidones, polyethylene glycols, polyvinyl alcohols, polyvinylmethyl ethers, polyacrylic acids, polyacrylic acid salts, polyvinylacrylic acids, polyvinylacrylic acid salts, polyacrylimides, ethylene oxide polymers, polylactic acid, synthetic clay, styrene-butadiene copolymers, latex, copolymers thereof, mixtures thereof, and the like. Plasticizers mat be used to increase, softness, flexibility, and toughness of the final product, and/or is added to the dry binder composition to facilitate processing.

In one exemplary embodiment, the dry binder composition comprises the at least one plasticizer in an amount between about 20% by weight of the dry binder composition and 35% by weight of the dry binder composition.

In another exemplary embodiment, the at least one mineral admixture is selected from the group comprising ground granulated blast-furnace slag, white cement, slag cement, calcium aluminate cement, silicate cement, phosphate cement, high-alumina cement, magnesium oxychloride cement, oil well cements (e.g., Type VI, VII and VIII), natural cement, portland cement, modified portland cement, masonry cement, hydraulic hydrated lime, and combinations of these and other materials.

In one exemplary embodiment, the dry binder composition comprises the at least one mineral admixture in an amount between about 10% by weight of the dry binder composition and 20% by weight of the dry binder composition.

In another exemplary embodiment, the at least one filler material is selected from the group comprising calcium carbonate (limestone), rock aggregate, talc, gypsum, silica, quartz, crushed marble, glass, granite, calcite, feldspar, alluvial sand, sands or any durable aggregate, perlite, vermiculite, sand, gravel, rock, limestone, sandstone, glass beads, aerogels, xerogels, seagel, mica, clay, synthetic clay, alumina, silica, fly ash, silica fume, tabular alumina, kaolin, microspheres, hollow glass spheres, porous ceramic spheres, gypsum dihydrate, calcium carbonate, calcium aluminate, cork, seeds, lightweight polymers, xonotlite (a crystalline calcium silicate gel), lightweight expanded clays, unreacted cement particles, pumice, exfoliated rock, and other geologic materials, and mixtures thereof.

In another exemplary embodiment, the dry binder composition comprises the at least one filler material in an amount between about 5% by weight of the dry binder composition and 19% by weight of the dry binder composition.

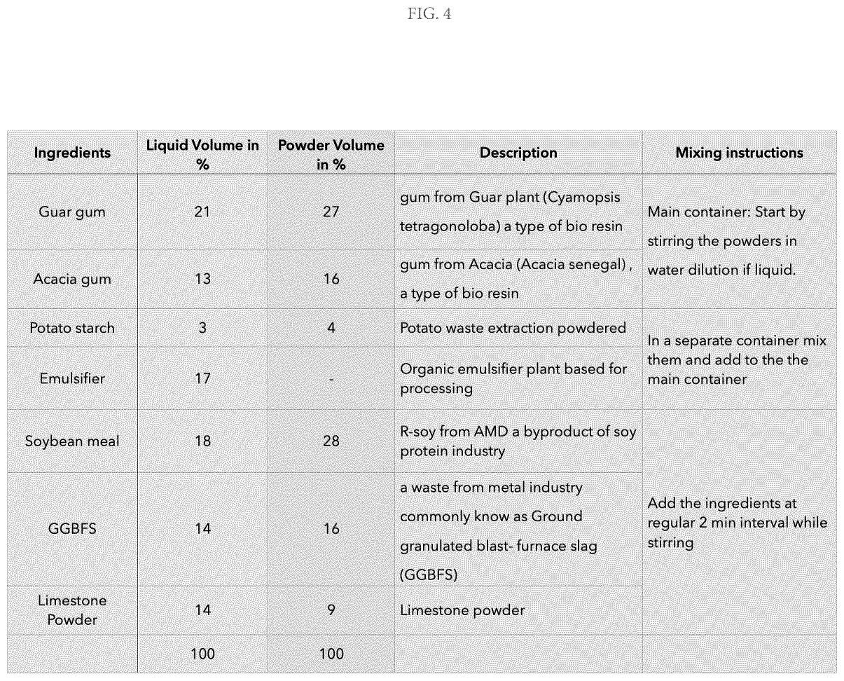

FIG. 4 illustrates a component matrix of an exemplary binder. Guar gum and Acacia gum are the first and second biopolymers, making of 27% and 16% of the binder composition by volume, respectively. Potato starch is the starch component making up 4% of the binder composition by volume. Soybean meal acts as the plasticizer component making up 28% of the binder composition by volume. Ground granulated blast-furnace slag is the mineral admixture that makes up 16% of the binder composition by volume. Limestone powder acts as the filler material making up 9% of the binder composition by volume.

According to certain embodiments, a method of making a liquid binder composition is provided. The method comprises combining at least one starch and the emulsifier together with water and mixing the combined at least one starch, emulsifier, and water thoroughly to create a first mixture. The method further comprises combining a first biopolymer, second biopolymer, at least one plasticizer, at least one mineral admixture, and at least one filler material with water and mixing the combined first biopolymer, second biopolymer, at least one plasticizer, at least one mineral admixture, at least one filler material and water thoroughly to create a second mixture. The method further comprises combining the first mixture and second mixture such that the ratio of water in the combined first mixture and second mixture to at least one starch, emulsifier, first biopolymer, second biopolymer, at least one plasticizer, at least one mineral admixture, and at least one filler material is maintained between about 1:2 to about 2:5.

The emulsifier will generally be both hydrophobic and hydrophilic, with common examples being coconut or other plant-based derivatives which serve the function of facilitating the mixture of the binder composition.

In another exemplary embodiment, the at least one starch and the emulsifier are combined with water between 68- and 74-degrees Fahrenheit. In another exemplary embodiment, the ratio of water to the combined at least one starch and emulsifier is between about 1:10 to about 2:10.

In another exemplary embodiment, the first biopolymer, second biopolymer, at least one plasticizer, at least one mineral admixture, and at least one filler material are combined with water between 68 and 74 degrees Fahrenheit. In another exemplary embodiment, the ratio of water to the combined first biopolymer, second biopolymer, at least one plasticizer, at least one mineral admixture, and at least one filler material is between about 1:10 to about 2:10.

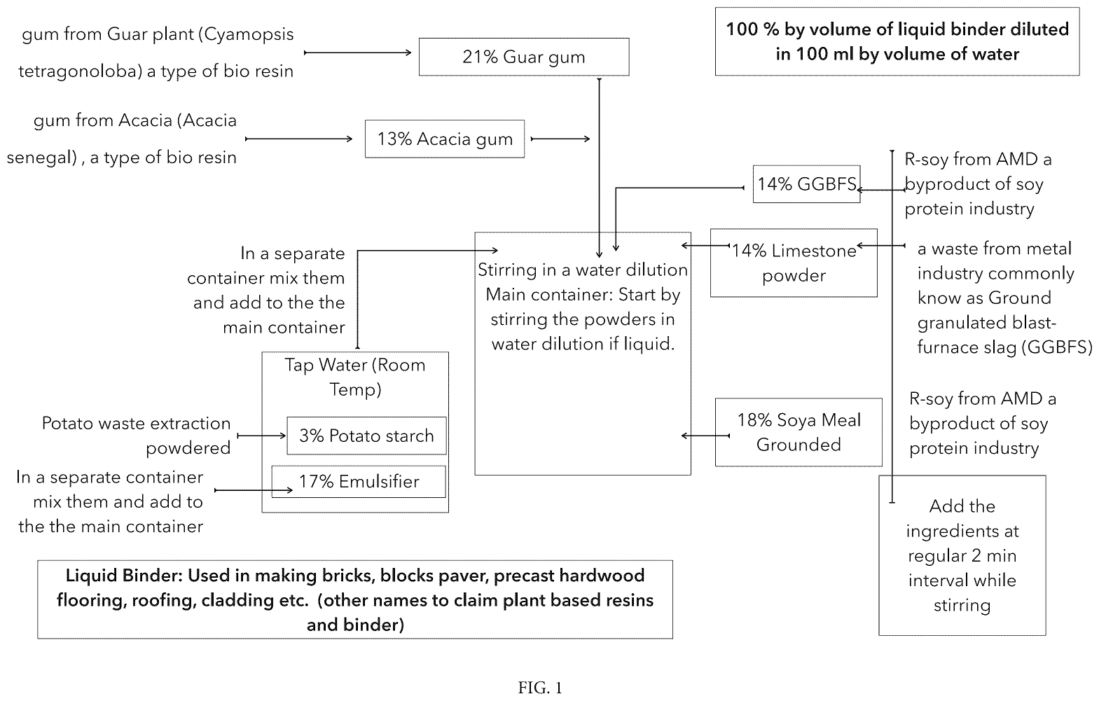

FIG. 1 illustrates an exemplary process by which a binder, in liquid form, may be formed. Guar gum and Acacia gum are the first and second biopolymers, making of 21% and 13% of the liquid binder composition by volume, respectively. Potato starch is the starch component which is first added with an emulsifier such a coconut oil and water to create a pre-mixture making up 20% of the liquid binder composition by volume. Soybean meal acts as the plasticizer component making up 18% of the liquid binder composition by volume. Ground granulated blast-furnace slag is the mineral admixture that makes up 16% of the binder composition by volume. Limestone powder acts as the filler material making up 14% of the liquid binder composition by volume.

According to certain embodiments, a concrete composition is provided. In one embodiment, the concrete composition comprises a binder comprising a first biopolymer, a second biopolymer, at least one starch, at least one plasticizer, at least one mineral admixture, and at least one filler material; a first garbage of bituminous derivative; a second garbage of bituminous derivative; a third garbage of bituminous derivative; and water.

In an exemplary embodiment, the binder is in an amount between around 5% and 15% by volume of the concrete composition.

In another exemplary embodiment, the first garbage of bituminous derivative is fine powder between around 10 and 40 microns and in an amount between around 60% and 70% by volume of the concrete composition.

In another exemplary embodiment, the second garbage of bituminous derivate is sand between around 1 and 6 mm in diameter and in an amount between around 10% and 15% by volume of the concrete composition.

In another exemplary embodiment, the third garbage of bituminous derivative is aggregate between around 6 and 12 mm in diameter and in an amount between around 5% and 10% by volume of the concrete composition.

In another exemplary embodiment, the water is in an amount between around 2% and 10% by volume of the concrete composition.

In an exemplary embodiment, garbage of bituminous is waste that is generated from the coal mining industry. The garbage of bituminous may mostly be composed of various components including sludge shale, slate, small coal pieces, clay, and materials discarded during coal mining.

In an exemplary embodiment, the garbage of bituminous is sent to a washing unit that separates the wet slurry or sludge, shale, and coal pieces in the container. The washing unit may use water to filter out heavy metals from the garbage of bituminous. In another exemplary embodiment, the water used in the washing unit may be passed through a filter and reused into the washing unit process. The heavy metals and other contaminants from the filtrate may be extracted and sent for chemical manufacturing.

In an exemplary embodiment, the coal pieces are separated from the washing unit. The coal may then be crushed and grinded to be used in charcoal manufacturing or other applications.

In an exemplary embodiment, the wet slurry or sludge from the washing unit is sieved through one or more sieves and divided into wet slurry, medium particles, and large particles. In one embodiment, the medium particles are between around 0 and 6 mm in diameter and the large particles are between around 6 and 12 mm in diameter. However, different separation techniques and/or sieves may be used to separate particles in various different size ranges.

In an exemplary embodiment, the large shale pieces in the washing unit may be separated and crushed into smaller pieces. After the large shale pieces are crushed into smaller pieces, they may be dried, which may be done using a variety of grinding and related techniques. In an exemplary embodiment, the large particles separated from the sieves or other separation mechanism are added in with the crushed large shale pieces at the drying stage, and the combination may be used as the third garbage of bituminous derivative.

In an exemplary embodiment, the wet slurry or sludge from the washing unit is separated and dried, which may be done using a variety of drying techniques. The dried wet slurry or sludge may then be crushed and ground to a desired size for the first garbage of bituminous derivative. In an exemplary embodiment, the dried wet slurry or sludge is crushed and ground into a fine powder between around 10 and 40 microns in diameter.

In another exemplary embodiment, the medium particles separated from the sieves or other separation mechanism may be used interchangeable or as a replacement for the second garbage of bituminous derivate.

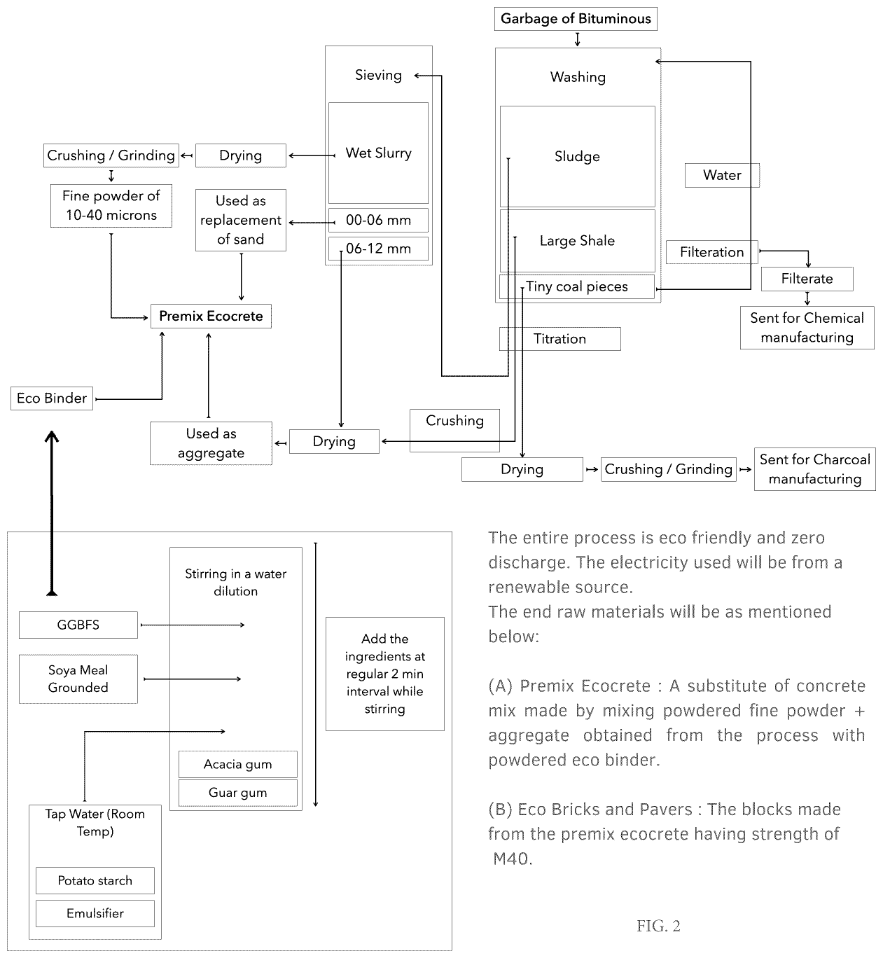

FIG. 2 illustrates an exemplary method of producing a concrete composition. Garbage of bituminous is processed via washing to separate sludge, large shale and coal fine (tiny coal pieces). The extracted sludge is further processed to separate its constituent solid particles by diameter into fine powders between 10-40 microns in diameter, sand-approximating particles of up to 6 mm in diameter, and aggregate particles between 6-12 mm in diameter. The large shale is crushed and dried, leaving aggregate particles above 12 mm in diameter. The liquid binder described supra is added to the sludge and large shale derivative components to create the concrete composition.

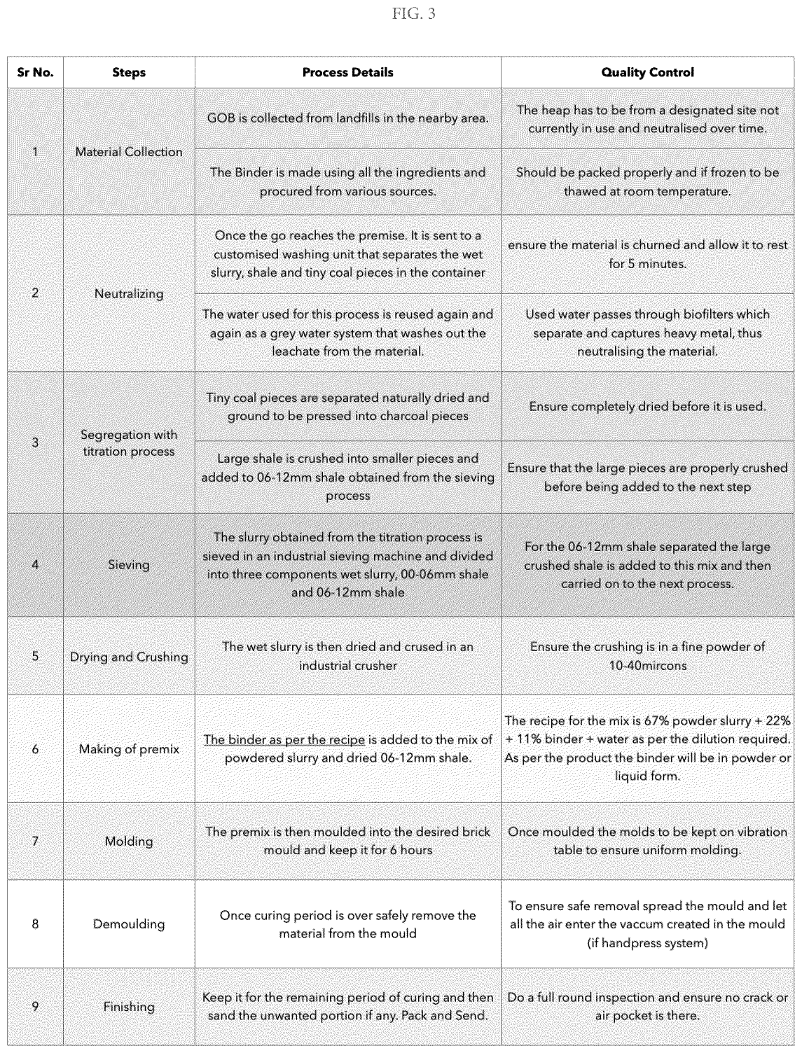

FIG. 3 illustrates an exemplary method of create bricks from the disclosed concrete composition. As described herein, GOB is processed to create aggregate and particles of various sizes, and then combined with a binder as described herein. The concrete composition is poured into molds, preferably subject to vibration to ensuring consistent curing, and then removed from the mold for use.

As described herein, the invention uses biologically derived materials to make useful notorious waste products by forming into concrete compositions. The concrete compositions may be used as bricks for construction or roads, or in a variety of civil engineering, home furnishing, or decorative applications.

While invention and methods of use thereof have been described with reference to certain embodiments, various modifications thereof will be apparent to those skilled in the art without departing from the scope of the invention.

I claim:

1. A dry binder composition product comprising:
a first biopolymer;
a second biopolymer;
at least one starch;
at least one plasticizer;
at least one mineral admixture;
at least one filler material;

2. The composition of claim 1, wherein the first biopolymer is guar gum.

3. The composition of claim 2, wherein the composition comprises guar gum in an amount between 22% and 33% by weight.

4. The composition of claim 1, wherein the second biopolymer is acacia gum.

5. The composition of claim 4, wherein the composition comprises acacia gum in an amount between 10% and 20% by weight.

6. The composition of claim 1, wherein the at least one starch is potato starch.

7. The composition of claim 6, wherein the composition comprises potato starch in an amount between 1% and 10% by weight.

8. The composition of claim 1, wherein the at least one plasticizer is soybean meal.

9. The composition of claim 8, wherein the composition comprises soybean meal in an amount between 20% and 35% by weight.

10. The composition of claim 1, wherein the at least one mineral admixture is granulated blastfurnace slag.

11. The composition of claim 11, wherein the composition comprises granulated blastfurnace slag in an amount between 10% and 20% by weight.

12. The composition of claim 1, wherein the at least one filler material is limestone powder.

13. The composition of claim 12, wherein the composition comprises limestone powder in an amount between 5% and 10% by weight.

14. A method of producing a liquid binder composition product comprising:
providing a first biopolymer;
providing a second biopolymer;
providing at least one starch;
providing at least one plasticizer;
providing at least one mineral admixture;
providing at least one filler material;
providing an emulsifier;
combining the at least one starch and the emulsifier together with water between 68 and 74 degrees Fahrenheit, wherein the ratio of water to the combined at least one starch and emulsifier is between about 1:10 to about 2:10;
mixing the combined at least one starch, emulsifier, and water thoroughly to create a first mixture;
combining the first biopolymer, second biopolymer, at least one plasticizer, at least one mineral admixture, and at least one filler material together with water between 68 and 74 degree Fahrenheit, wherein the ratio of water to the combined first biopolymer, second biopolymer, at least one plasticizer, at least one mineral admixture, and at least one filler material is between about 1:10 to about 2:10;
mixing the combined first biopolymer, second biopolymer, at least one plasticizer, at least one mineral admixture, at least one filler material, and water thoroughly to create a second mixture;
combining the first mixture and second mixture such that the ratio of water in the combined first mixture and second mixture to at least one starch, emulsifier, first biopolymer, second biopolymer, at least one plasticizer, at least one mineral admixture, and at least one filler material is maintained between about 1:2 to about 2:5.

15. The method of claim 14, wherein the first biopolymer is guar gum.

16. The method of claim 14, wherein the second biopolymer is acacia gum.

17. The method of claim 14, wherein the at least one starch is potato starch.

18. The method of claim 14, wherein the at least one plasticizer is soybean meal.

19. The method of claim 14, wherein the at least one mineral admixture is granulated blastfurnace slag.

20. The method of claim 14, wherein the at least one filler material is limestone powder.

21. The method of claim 14, wherein the emulsifier is coconut oil.

22. A concrete composition product comprising
a binder comprising a first biopolymer, a second biopolymer, at least one starch, at least one plasticizer, at least one mineral admixture, and at least one filler material in an amount between 5 and 15% by volume
a first garbage of bituminous derivative wherein the first derivative is fine powder between 10 and 40 microns in an amount between 60 and 70% by volume
a second garbage of bituminous derivative wherein the second derivative is sand between 1 and 6 mm in an amount between 10 and 15% by volume
a third garbage of bituminous derivative wherein the third derivative is aggregate between 6 and 12 mm in an amount between 5 and 10% by volume
water in an amount between 2 and 10% by volume
